(19) United States
(12) Patent Application Publication
(10) Pub. No.: US 2013/0169109 A1
(43) Pub. Date: Jul. 4, 2013

(54) COMB ELECTRODE STRUCTURE

(71) Applicants: Ming-Fa CHEN, Taoyuan (TW); Bor-Shiun Lee, Taoyuan (TW)

(72) Inventors: Ming-Fa CHEN, Taoyuan (TW); Bor-Shiun Lee, Taoyuan (TW)

(73) Assignee: TOUCH MICRO-SYSTEM TECHNOLOGY CORPORATION, Yangmei City (TW)

(21) Appl. No.: 13/444,019

(22) Filed: Apr. 11, 2012

(30) Foreign Application Priority Data
Jan. 3, 2012 (TW) 101100236

(51) Int. Cl. H02N 1/00

(52) U.S. Cl. 310/309

(57) ABSTRACT

A comb electrode structure including a plurality of first comb fingers, a plurality of second comb fingers and a first reinforced comb finger is provided. The first comb fingers and the second comb fingers are interlaced with each other. The first reinforced comb finger is located at the outermost side of the first comb fingers, and electrically connected to the first comb fingers. In an embodiment, the width of the first reinforced comb finger is greater than that of the first comb fingers. In another embodiment, the thickness of the first reinforced comb finger is greater than that of the first comb fingers.

This application claims the benefit of Taiwan application Serial No. 101100236, filed Jan. 3, 2012, the subject matter of which is incorporated herein by reference.

### BACKGROUND OF THE INVENTION

1. Field of the Invention

The invention relates in general to a micro-electromechanical structure, and more particularly to a comb electrode structure used in a micro-electromechanical device.

2. Description of the Related Art

The optical application of the micro-electromechanical mirror (MEMS mirror) aims to achieve largest angle optical scanning given that the mirror vibrates at a specific frequency under predetermined driving conditions. Of the different types of micro-electromechanical actuators that are already provided, the comb electrode structure driven by electrostatic force has the greatest potential of being used in the actuator. When electrostatic attraction occurs between the comb fingers of a comb electrode structure, the mirror is rotated to the largest angle of inclination around the twisted object. For each comb finger, the left side and the right side both generate the same electrostatic force and are thus balanced. However, for the outermost comb finger, only one of the two sides generates electrostatic force, so the stresses applied on the sides of the outermost comb finger are imbalanced. Once the electrostatic force is greater than the strength of the outermost comb fingers, the outermost comb finger will be deformed and lean towards or even contact a neighboring comb finger. Consequently, pull-in phenomenon may occur and make the comb electrode structure short-circuited.

### SUMMARY OF THE INVENTION

The invention is directed to a comb electrode structure enabling the outermost comb finger operated under a high voltage to bear imbalanced electrostatic force so that the comb electrode structure will not be deformed due to imbalanced stress.

According to a first aspect of the present invention, a comb electrode structure including a plurality of first comb fingers, a plurality of second comb fingers and a first reinforced comb finger is provided. The first comb fingers and the second comb fingers are interlaced with each other. The first reinforced comb finger is located at the outermost side of the first comb fingers, and electrically connected to the first comb fingers. The width of the first reinforced comb finger is greater than that of the first comb fingers.

According to a second aspect of the present invention, a comb electrode structure including a plurality of first comb fingers, a plurality of second comb fingers and a first reinforced comb finger is provided. The first comb fingers and the second comb fingers are interlaced with each other. The first reinforced comb finger is located at the outermost side of the first comb fingers, and electrically connected to the first comb fingers. The thickness of the first reinforced comb finger is greater than that of the first comb fingers.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a comb electrode structure according to an embodiment of the invention;

FIG. 2 shows a cross-sectional view of along a cross-sectional line I-I of the first reinforced comb finger of FIG. 1;

FIG. 3 shows a comb electrode structure according to an embodiment of the invention; and

FIG. 4 shows a cross-sectional view along a cross-sectional line I-I of the second reinforced comb finger of FIG. 3.

### DETAILED DESCRIPTION OF THE INVENTION

The comb electrode structure of the present embodiment of the invention may be used as a driver in a micro-electromechanical device. The micro-electromechanical device is such as a micro-electromechanical mirror device, a micro clipper or a switch device. The comb electrode structure can be used to control the vibration frequency of a micro-mirror and make the micro-electromechanical mirror device even more compact and miniaturized and capable of adjusting the vibration frequency in a real-time manner so as to replace the conventional multi-rotating mirror. The comb electrode structure can be used to control the movement of the micro clipper for capturing the atoms or for capturing a micro object or biomolecules in a microscopy system. The switch of a micro-electromechanical system can be activated by electrostatic force, magnetic force or the electricity force generated from thermoelectric conversion, and may be used in optical communication module, integrated circuit module or other control module.

A number of embodiments are disclosed below for elaborating the invention. However, the embodiments of the invention are for detailed descriptions only, not for limiting the scope of protection of the invention.

### First Embodiment

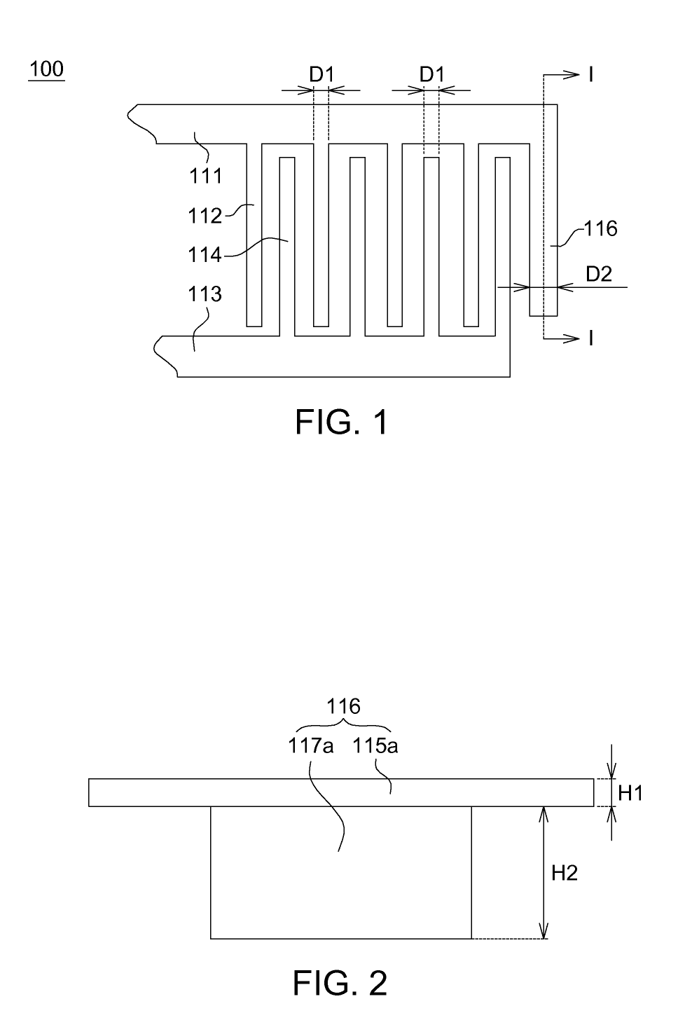

Referring to FIG. 1, a comb electrode structure according to an embodiment of the invention. The comb electrode structure 100 includes a plurality of first comb fingers 112, a plurality of second comb fingers 114 and a first reinforced comb finger 116. The first comb fingers 112 and the second comb fingers 114 are comb electrodes arranged in a periodic manner. The first comb fingers 112 and the second comb fingers 114 are interlaced with each other, and have the same quantity.

In the present embodiment, the first comb fingers 112 are interconnected via a cantilever 111, and the second comb fingers 114 are interconnected via another cantilever 113, such that the first comb fingers 112 and the second comb fingers 114 are interlaced between two cantilevers 111 and 113, and are arranged at an equal interval.

The interval between each first comb finger 112 and its two neighboring second comb fingers 114 is such as 3 micro-meters. The first comb fingers 112 and the second comb fingers 114 have opposite electric properties (positive polarity or negative polarity). Therefore, when electrostatic force occurs between each first comb finger 112 and its two neighboring second comb fingers 114, the first comb finger 112 will not be deformed because the stresses applied on the two sides are balanced.

The first reinforced comb finger 116 is located at the outermost side of the first comb fingers 112 and electrically connected to the first comb finger 112 via the cantilever 111. Under such circumstances, electrostatic force is generated on only one side of the first reinforced comb finger 116 located at the outermost side. With the width of the first reinforced comb finger 116 being increased, the first reinforced comb finger 116 is capable of bearing the stress generated by imbalanced electrostatic force.

Referring to FIG. 1, the width D2 of the first reinforced comb finger 116 is greater than the width D1 of the first comb finger 112 and the second comb finger 114. In an embodiment, the width D2 of the first reinforced comb finger 116 may be 2 or 1.5 times of the width D1 of the first comb finger 112 and the second comb finger 114. The range of width is such as 1.1D1≦D2≦2D1. However, the invention is not subjected to the above exemplification. Preferably, the width D2 of the first reinforced comb finger 116 is adjusted according to the magnitude of electrostatic force bearable to one single side. Experimental analysis shows that when the width of the first reinforced comb finger 116 is equal to 5 micro-meters, and the interval between the first reinforced comb finger 116 and the outermost second comb finger 114 is 3 micro-meters, the first reinforced comb finger 116 can resist the electrostatic force generated under a higher driving voltage (such as 150V) and the pull-in phenomenon will not occur.

Referring to FIG. 2, a cross-sectional view of along a cross-sectional line I-I of the first reinforced comb finger 116 of FIG. 1 is sown. In the above embodiment, the structural strength of the first reinforced comb finger 116 in the width direction is enhanced. In the present embodiment, the structural strength of the first reinforced comb finger 116 in the thickness direction is enhanced in a manner that the thickness (H1+H2) of the first reinforced comb finger 116 is greater than the thickness H1 of the first comb finger 112 and the second comb finger 114, so that the outermost comb fingers will not be deformed.

The first reinforced comb finger 116 includes a first electrode portion 115a and a first reinforced rib 117a. The thickness H1 of the first electrode portion 115a is approximately equal to the thickness of the first comb fingers 112 and the second comb fingers 114. The first reinforced rib 117a is located at the bottom of the first electrode portion 115a, such that the first reinforced rib 117a overlaps the first electrode portion 115a, and the thickness H2 of the first reinforced rib 117a is greater than the thickness H1 of the first electrode portion 115a. The thickness H2 of the first reinforced rib 117a may be equal to 3 or 2 times of the thickness H1 of the first electrode portion 115a. The range of the thickness is such as 1.1H1≦H2≦3H1. However, the invention is not subjected to the above exemplification. Preferably, the total thickness (H1+H2) of the first reinforced comb finger 116 is adjusted according to the magnitude of electrostatic force bearable on one single side. The first reinforced rib 117a, made from semiconductor or metal by way of lithography and etching, may be formed at the bottom of the first electrode portion 115a. The first reinforced comb finger 116 with an increased thickness can bear imbalanced electrostatic force generated under a higher driving voltage (such as 150V) to avoid the comb fingers being deformed by imbalanced stress.

### Second Embodiment

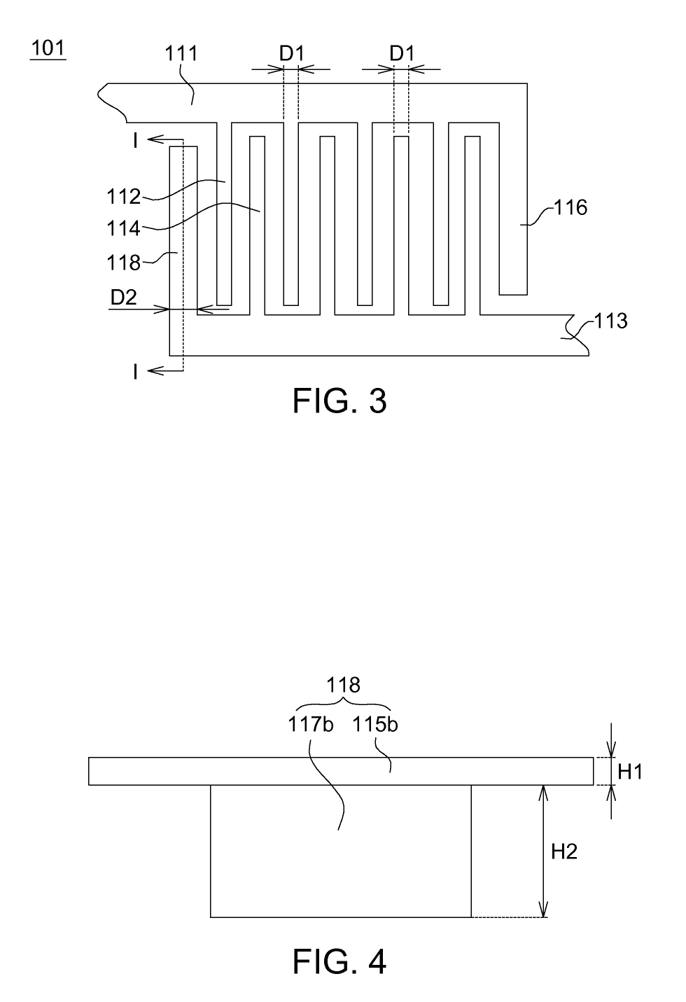

Referring to FIG. 3, a comb electrode structure according to an embodiment of the invention is shown. The comb electrode structure 101 includes a plurality of first comb fingers 112, a plurality of second comb fingers 114, a first reinforced comb finger 116 and a second reinforced comb finger 118. Detailed descriptions of the first comb fingers 112, the second comb fingers 114 and the first reinforced comb finger 116 are disclosed in the first embodiment, and are not repeated here. The present embodiment is different from the first embodiment in that: the second reinforced comb finger 118 is located at the outermost side of the second comb fingers 114 and electrically connected to the second comb fingers 114 via the cantilever 113. As indicated in FIG. 3, the first reinforced comb finger 116 is located at the rightmost side of the first comb fingers 112, and the second reinforced comb finger 118 is located at the leftmost side of the second comb fingers 114. The first comb fingers 112 and the second comb fingers 114, located between the first and the second reinforced comb fingers 116 and 118, are interlaced with each other and have the same quantity.

In the present embodiment, the first and the second reinforced comb fingers 116 and 118 are respectively located at the outermost side. Under such circumstances, the electrostatic force is generated only one side of the first and the second reinforced comb fingers 116 and 118. With the width D2 of the first and the second reinforced comb fingers 116 and 118 being increased, the first and the second reinforced comb fingers 116 and 118 are both capable of bearing the stress generated by imbalanced electrostatic force.

Referring to FIG. 4, a cross-sectional view along a cross-sectional line I-I of the second reinforced comb finger 118 of FIG. 3 is shown. The second reinforced comb finger 118 includes a second electrode portion 115b and a second reinforced rib 117b. The second reinforced rib 117b overlaps the second electrode portion 115b. The thickness of the second reinforced rib 117b is greater than that of the second electrode portion 115b. The thickness H1 of the second electrode portion 115b is approximately equal to the thickness of the first comb fingers 112 and the second comb fingers 114. The thickness H2 of the second reinforced rib 117b may be equal to 3 or 2 times of the thickness H1 of the second electrode portion 115b. The range of the thickness is such as 1.1H1≦H2≦3H1. However, the invention is not subjected to the above exemplification. Preferably, the total thickness (H1+H2) of the second reinforced comb finger 118 is adjusted according to the magnitude of electrostatic force bearable to one single side. The second reinforced rib 117b, made from semiconductor or metal by way of lithography and etching, may be formed at the bottom of the second electrode portion 115b. The second reinforced comb finger 118 with an increased thickness can bear imbalanced electrostatic force generated under a higher driving voltage (such as 150V) to avoid the comb fingers being deformed by imbalanced stress.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A comb electrode structure, comprising:
a plurality of first comb fingers;
a plurality of second comb fingers interlaced with the first comb fingers; and
a first reinforced comb finger located at the outermost side of the first comb fingers and electrically connected to the first comb fingers, wherein a width of the first reinforced comb finger is greater than that of the first comb fingers.

2. The comb electrode structure according to claim 1, wherein the width of the first reinforced comb finger is greater than that of the second comb fingers.

3. The comb electrode structure according to claim 1, further comprising a second reinforced comb finger located at the outermost side of the second comb fingers and electrically connected to the second comb fingers, wherein a width of the second reinforced comb finger is greater than that of the second comb fingers.

4. The comb electrode structure according to claim 3, wherein the width of the second reinforced comb finger is greater than that of the first comb fingers.

5. A comb electrode structure, comprising:
a plurality of first comb fingers;
a plurality of second comb fingers interlaced with the first comb fingers; and
a first reinforced comb finger located at the outermost side of the first comb fingers and electrically connected to the first comb fingers, wherein a thickness of the first reinforced comb finger is greater than that of the first comb fingers.

6. The comb electrode structure according to claim 5, wherein the thickness of the first reinforced comb finger is greater than that of the second comb fingers.

7. The comb electrode structure according to claim 5, wherein the first reinforced comb finger comprises a first electrode portion and a first reinforced rib, the first reinforced rib overlaps the first electrode portion, and a thickness of the first reinforced rib is greater than that of the first electrode portion.

8. The comb electrode structure according to claim 5, further comprising a second reinforced comb finger located at the outermost side of the second comb fingers and electrically connected to the second comb fingers, wherein a thickness of the second reinforced comb finger is greater than that of the second comb fingers.

9. The comb electrode structure according to claim 8, wherein the thickness of the second reinforced comb finger is greater than that of the first comb fingers.

10. The comb electrode structure according to claim 8, wherein the second reinforced comb finger comprises a second electrode portion and a second reinforced rib, the second reinforced rib overlaps the second electrode portion, and a thickness of the second reinforced rib is greater than that of the second electrode portion.
